(19) United States
(12) Patent Application Publication
(10) Pub. No.: US 2013/0290131 A1
(43) Pub. Date: Oct. 31, 2013

(54) METHOD AND ARRANGEMENT FOR ENABLING CUSTOMIZED RECOMMENDATIONS

(71) Applicants: Jonas Björk, Stockholm (SE); Simon Moritz, Stockholm (SE); Rickard Cöster, Hagersten (SE)

(72) Inventors: Jonas Björk, Stockholm (SE); Simon Moritz, Stockholm (SE); Rickard Cöster, Hagersten (SE)

(73) Assignee: Telefonaktiebolaget L M Ericsson (publ), Stockholm (SE)

(21) Appl. No.: 13/997,931

(22) PCT Filed: Dec. 27, 2010
(86) PCT No.: PCT/SE10/51482

§ 371 Date: Jun. 25, 2013

(51) Int. Cl. G06Q 30/06

(52) U.S. Cl. CPC G06Q 30/0631
USPC 705/26.7

(57) ABSTRACT

A method and arrangement for enabling creation of customized recommendations of items for persons (100) using a consumption device (102). Consumption samples are registered which refer to the consumption of items on the consumption device. Then, ratings of predefined features are determined from the consumption samples to form an aggregated profile (104b) of the persons. Individual taste profiles (104d) are then extracted from the aggregated profile by using an ICA algorithm (104c). Each taste profile reflects a distinct taste amongst the persons. The individual taste profiles can then be provided to a recommendation system (106) which is able to create customized recommendations of items (110).

### TECHNICAL FIELD

The invention relates generally to a method and arrangement for enabling creation of customized recommendations of items based on taste analysis of item consumers.

### BACKGROUND

Recently, various solutions and mechanisms have been developed for creating customized or “personalized” recommendations to users in a communication network, for consuming or otherwise using different products and services. It has become quite common to present recommendations of products and services that are offered for sale from a web-based shop or retailer to potential customers, where the recommendations have been selected and/or somehow adapted to specific needs, preferences and interests of the customers. The adapted or customized recommendations may be presented to potential customers by various providers and suppliers of products and services, in order to achieve efficiency in their marketing activities and offerings. Thereby, the customers will also be better served by receiving more relevant and interesting recommendations which could increase their general responsiveness to such recommendations.

In this description, recommendations as described above will be referred to as “customized” recommendations, in the sense that a customized recommendation is devised to potentially provide some value or interest to a particular targeted customer, regardless of whether he/she actually follows the recommendation or not. Alternatively, the term “personalized” could be used as equivalent to customized. Further, the term “item” will be used here to represent any product, article, object or service in any field of use, that can be recommended to a potential customer for usage or consumption.

The recommendation systems of today employ a filtering mechanism or the like for extracting items of interest to recommend, which can basically be divided into content based filtering and collaborative filtering. The content based filtering is configured to determine items to recommend depending on information and characteristics of the items and/or the users, while the collaborative filtering is based on ratings made by the users on different items. The ratings used in collaborative filtering may be either explicit or implicit. For example, a typical collaborative filtering algorithm determines items to recommend by comparing ratings of different items made by different users. The latter filtering mechanism may be either item-based by considering similarities of the item ratings, or user-based by considering similarities between the users having generated the ratings. By way of example, a typical recommendation could be: “customers who bought this product have also bought the following products . . . ”

In either case, in order to produce relevant and potentially interesting recommendations, information related to the individual users can be utilized, such as demographic data as well as information on purchased items, ratings made, and so forth. Mostly, recommendation systems are employed by various online-based enterprises such as web shops, content providers and retailers, which the users can access over the Internet by means of computers and communication terminals. In this process, it is commonly accepted that the user identifies herself and logs in to a personal account or the like. Thereby, the online enterprise is able to track browsing activities, ratings and consumption behaviour to individual users, and to use that information with reference to the users as input for producing recommendations accordingly. Practically all customized or personalized recommendation systems of today require some kind of personal login procedure.

However, in other situations where no personal identification or login procedure is required or generally accepted, this type of information on the behaviour of specific users is not readily available for creating appropriate customized recommendations. For example, when a TV set in a household is being watched, it is possible to register what channels, TV shows and programs are being watched but it is not known which person(s) is/are present, the TV set being basically a “multi-user” consumption device typically used by all persons in the household, although different persons may of course use it at different occasions. It is therefore possible to create recommendations of items to a household as a whole, even though that household typically comprise plural persons with disparate habits, needs, preferences and interests. A recommendation to a household may therefore be relevant to one person but improper to another.

In a family household, for example, children and parents have typically quite different tastes and watching habits regarding programs, time of day, watching schedules and motivation for watching. The watching behaviour that can be registered by means of a TV set, e.g. by detecting the TV's activities, will inevitably be an aggregation or the sum of all the users' behaviour. In contrast, a PC or mobile phone/cell phone is typically used by one specific person at a time that can be identified by a login procedure, which is generally accepted when using such devices. It is thus not accepted by people in general to perform login to a TV.

In conclusion, since a recommendation system cannot identify the person(s) using a multi-user consumption device, such as a TV set, it is a problem that no fitting customized recommendation can be created based on activities registered by such a device that can be employed by plural users without identification. It has been proposed to create personal channels on a TV allowing the user to create and control his/her own channel which can be populated automatically with content similar to some initial content chosen by the users. The consumption patterns of a personal TV channel may thus be associated with a specific user who can be identified. However, this solution requires the user to actively configure the personal channel which may be regarded as an inconvenience, and it is also rather static and limited in the sense that the consumption that can be registered is restricted to the content on that channel only.

### SUMMARY

It is an object of the invention to address at least some of the problems and shortcomings outlined above. It is also an object to enable creation of customized recommendations of items for one or more users potentially having disparate needs, preferences and interests. It is possible to achieve these objects and others by using a method and an arrangement as defined in the attached independent claims.

According to one aspect, a method is provided in a profile analyser or equivalent entity, for enabling creation of customized recommendations of items for one or more persons using a consumption device. In this method, consumption samples are registered which refer to the consumption of items by means of the consumption device. From the registered consumption samples, ratings of a plurality of predefined features are determined, where the ratings form an aggregated profile which reflects an aggregated taste of the one or more persons.

Individual taste profiles are then extracted from the aggregated profile by applying an ICA (Independent Component Analysis) algorithm to the ratings in the aggregated profile. The ICA algorithm is capable of separating a multivariate signal into additive subcomponents, and each taste profile reflects a distinct taste amongst the one or more persons. One or more of the individual taste profiles can then be provided to a recommendation system or the like, to enable creation of one or more customized recommendations of items adapted for at least one of the individual taste profiles.

When using this method, no manual input is required from the users for login and identification. Further, it is not necessary to identify which persons are using the consumption device and the taste profiles are not matched to specific persons, thus allowing for privacy and integrity. It is also possible to define useful taste profiles with great accuracy and refinement.

According to another aspect, an arrangement is provided in a profile analyser configured to enable creation of customized recommendations of items for one or more persons using a consumption device. In this arrangement, a registering module in the profile analyser is adapted to register consumption samples referring to the consumption of items by means of the consumption device. Further, a rating module in the profile analyser is adapted to determine ratings of a plurality of predefined features from the registered consumption samples, the ratings forming an aggregated profile reflecting an aggregated taste of the one or more persons.

The arrangement in the profile analyser also comprises a profile module adapted to extract individual taste profiles from the aggregated profile by applying an ICA (Independent Component Analysis) algorithm to the ratings in the aggregated profile, the ICA algorithm being capable of separating a multivariate signal into additive subcomponents, each taste profile reflecting a distinct taste amongst the one or more persons. The arrangement also comprises a providing module adapted to provide one or more of the individual taste profiles to a recommendation system to enable creation of one or more customized recommendations of items adapted for at least one of the individual taste profiles.

The benefits of using this arrangement correspond to those mentioned above for the method. The consumption device may be a TV set, an STB (Set Top Box) or any type of media player, and the items may be TV programs or any other content products.

The above method and arrangement may be configured and implemented according to different optional embodiments. In one possible embodiment, the consumption samples are registered during one or more sampling periods, each sampling period starting when the consumption device is activated or when a change of present persons is detected, and ending when the consumption device is de-activated or when a change of present persons is detected.

In another possible embodiment, the ratings in the aggregated profile are values of the predefined features which comprise at least one of: item features referring to identities of the items, content features referring to descriptions of the items, and context features referring to a context prevalent when the items were consumed. The feature values in the aggregated profile may be defined as a feature vector Xₜ comprising coordinates corresponding to the predefined features of a sampling period t. Further, extracting the individual taste profiles may comprise determining values of the predefined features in a matrix S defining the taste profiles, each row in the matrix S containing feature values of an individual taste profile, from a matrix X defining the aggregated profile, each row in the matrix X containing feature values of a sampling period, by solving matrix S from X=A*S, using the ICA algorithm, where A is a transformation matrix.

In another possible embodiment, the rating for a feature f in the aggregated profile is multiplied by a weight factor w(f) to impose a corresponding emphasis or importance to the feature f. The weight factor w(f) may be a combination of a local weight l(f) and a global weight g(f): w(f)=l(f)*g(f), where the local weight l(f) refers to a particular item and the global weight g(f) refers to any items.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a block diagram illustrating a procedure for determining taste profiles, according to a possible embodiment.

FIGS. 2a-c illustrates examples of defining sampling periods, according to some possible embodiments.

FIG. 3 is a flow chart of a procedure for enabling customized recommendations, according to further possible embodiments.

FIG. 4 is an example scheme for determining taste profiles, according to further possible embodiments.

FIG. 5 is a block diagram illustrating an example profile analyser, according to further possible embodiments.

### DETAILED DESCRIPTION

Briefly described, a solution is provided to enable customized recommendations of items by creating a set of individual taste profiles based on item consumptions on a consumption device being used by one or more persons, e.g. in a household or the like. The consumption of items on the consumption device can be detected by registering “consumption samples” in a suitable manner, depending on the type of consumption device. In one optional and non-limiting example, the consumption device may be a TV set or STB (Set Top Box), and in that case the items are TV programs and a consumption sample would correspond to a period of watching the TV when it can be assumed that the same set of persons are likely present before the TV, herein generally called a “sampling period”.

However, this solution is not limited to TV and the consumption device may for example be any media player and the items may be any type of content products or similar. In the following description, the example of watching TV will be used throughout for simplicity to illustrate and explain the characteristics of this solution.

In this solution, an aggregated profile reflecting an aggregated taste of the one or more persons is formed from the registered consumption samples. In more detail, the aggregated profile is formed by determining ratings of features that have been predefined as being relevant to the consumption device, and these feature ratings, or at least some of them, can be determined from the items being consumed on that device. Any number of features N may have been defined to describe the aggregated profile, although it is not necessary to determine a rating value for all N features in a sampling period, depending on what items are consumed during that sampling period. A rating value can be set to zero when not relevant or applicable.

The feature ratings of a sampling period can be represented by a vector with plural coordinates in which each feature is represented by a coordinate. The aggregated profile may further be formed as a matrix X with multiple rows for different feature vectors of consumption samples and multiple columns for the N predefined features. As consumption samples are registered during one or more sampling periods, the matrix X can be populated with feature values of each sampling period, forming the corresponding feature vector. In this process, several features in the matrix may be left unpopulated, i.e. zero or lacking a value, if those features are not applicable for a particular sampling period depending on the nature of the items consumed during that period.

The aggregated profile can then be used to extract a set of individual taste profiles by applying a so-called “ICA (Independent Component Analysis)” algorithm to the ratings in the aggregated profile, ICA being known as a useful computational method for analysing data. Basically, an ICA algorithm is capable of separating a multivariate signal into additive subcomponents, which will be described in more detail later below. As a result, each taste profile reflects a distinct taste amongst the one or more persons.

In a useful but non-limiting example, an ICA algorithm is used to produce another matrix S with rows containing feature values of individual taste profiles, from the matrix X defining the aggregated profile, by solving matrix S from

X=A*S (1)

where A is a transformation matrix that can be determined together with matrix X by applying a suitable algorithm for identifying independent components, e.g. the algorithm known as “Fast ICA”. In the resulting matrix S, each row thus contains feature values that characterize an individual taste profile, which can be represented as an individual vector in an N-dimensional “space” of N features. M rows in matrix S thus correspond to M taste profiles.

An exemplifying illustration of equation (1) could be:

$$( \begin{matrix}{X}_{11} & {X}_{12} & … & {X}_{1 n} \\ {X}_{21} & {X}_{22} & & \\ ⋮ & & ⋱ & \\ {X}_{k 1} & & & {X}_{k n}\end{matrix} ) ( \begin{matrix}{a}_{11} & {a}_{12} & {a}_{13} & {a}_{14} \\ {a}_{21} & {a}_{22} & {a}_{23} & {a}_{24} \\ & & & \\ {a}_{k 1} & {a}_{k 2} & {a}_{k 3} & {a}_{k 4}\end{matrix} ) ( \begin{matrix}{s}_{11} & {s}_{12} & … & {s}_{1 n} \\ {s}_{21} & {s}_{22} & & {s}_{2 n} \\ {s}_{31} & {s}_{32} & & {s}_{3 n} \\ \text{?} & \text{?} & & \text{?}\end{matrix} ) = \text{?}$$

$$\text{?} \text{indicates text missing or illegible when filed}$$

where “X” are the determined feature ratings for k sampling periods and n features in the aggregated profile matrix X, “a” are coordinates in the transformation matrix A, and “s” are the resulting feature ratings of the individual taste profiles 1-4 in matrix S, each row thus comprising a feature vector of a taste profile.

For example, a particular taste profile may correspond to the taste of one particular person, although one and the same person could actually have more than one taste profile such as when preferring both romantic and action films, just to mention a simplified case. On the other hand, more than one person in a household could have the same taste profile, and this solution is quite flexible by not being limited to defining one taste per person or just a single common taste for all persons. Further, this solution does not require any identification whatsoever of which persons are consuming items during each sampling period since the individual taste profiles need not be tied to specific persons.

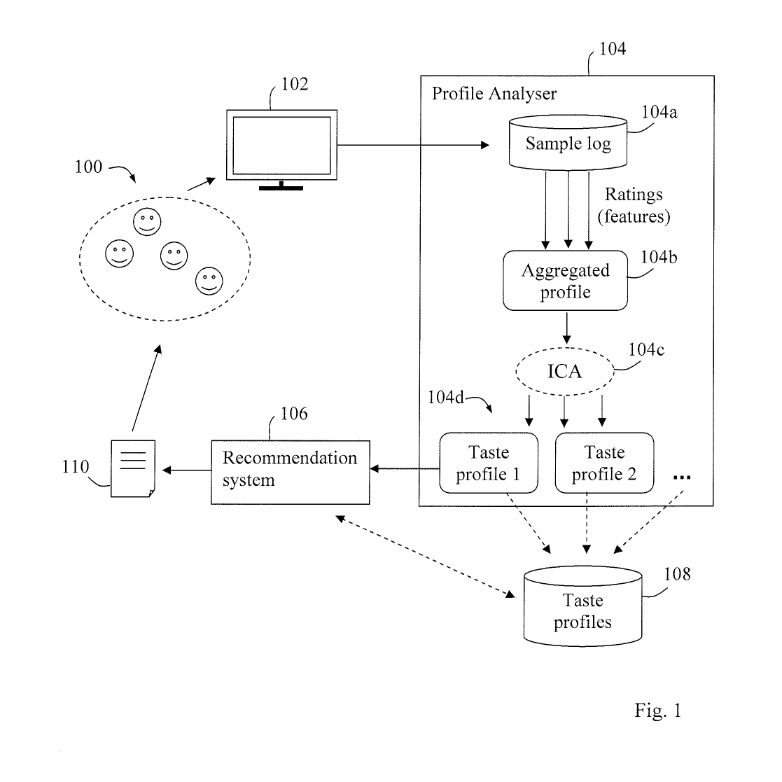

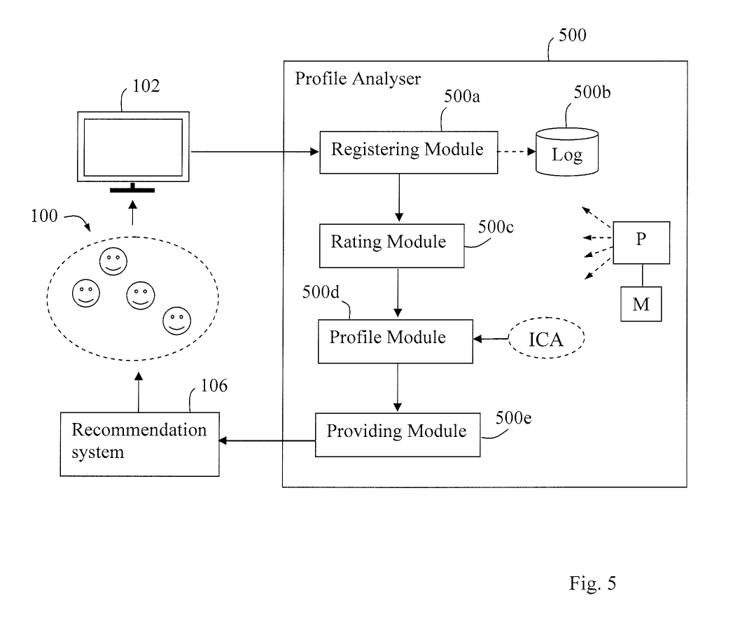

An illustrative example of employing this solution for enabling creation of customized recommendations of items, will now be described with reference to the block diagram in FIG. 1, where a set of persons 100 are potential consumers of items on a consumption device, in this case a TV set 102 displaying TV programs. This solution can be applied for basically any number of persons, even including just a single person. A process executed in a profile analyser 104 to produce a set of taste profiles, is schematically shown in the figure and can be realized by means of functional units or modules in profile analyser 104, to be described later below with reference to an exemplifying block diagram in FIG. 5.

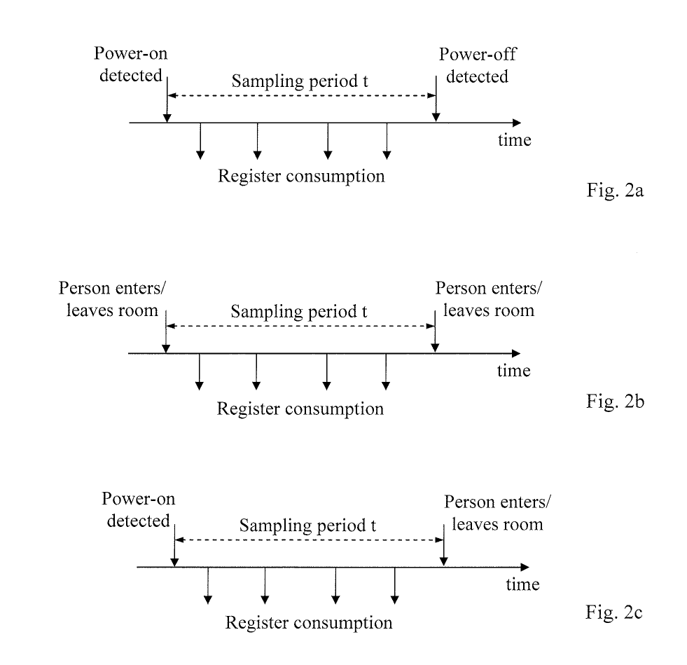

The item consumption on TV set 102 is logged by the profile analyser 104 by registering consumption samples during one or more sampling periods from the TV set 102 in a suitable manner. The mechanism used for registering consumption samples is however somewhat outside the scope of this invention and is highly dependent on the type of consumption device. For example, the TV set 102 may be configured to send reports to the profile analyser 104 regarding watched TV programs and/or channels, or alternatively the profile analyser 104 may be configured to fetch information regarding watched TV programs and/or channels from the TV set 102. A sampling period can be triggered in different ways, to be exemplified below with reference to FIGS. 2a-2c.

FIG. 1 illustrates schematically that information on consumed items from the TV set 102 is logged and stored as a sample log 104a or the like in the profile analyser 104. From this information, ratings of a set of predefined features can be determined which are used to form an aggregated profile 104b that reflects an aggregated taste of the persons 100. The predefined features can be defined in any suitable manner, preferably relevant to what items can be consumed on the consumption device. In the case of a TV set, the predefined features would typically relate to characteristics of programs that can be watched. The predefined features may also relate to the current environment at the consumption device.

In one optional implementation, the predefined features may basically be categorized into: 1) item features referring to identities of the items, 2) content features referring to descriptions of the items, e.g. genre, length, language, and 3) context features referring to a context prevalent when the items were consumed, e.g. referring to volume and light settings on the TV, the time of day, week or season, and also environmental factors such as location, temperature, background noise level, and so forth.

The item features may be explicit or implicit ratings, an explicit rating being a score or the like that a person in the household has actively assigned to a particular item, while an implicit rating of an item is implied by the consumption of that item. For example, an item feature may be related to the number of times a recurring program has been watched which may be watched on a regular basis, e.g. each week, and the feature rating may be defined to equal that number. A program may also be watched partly, e.g. the last 50%, which may generate a rating of 0,5. The feature may also be defined such that the rating for a partly consumed TV program is lower if it was turned off before it was finished, basically indicating that the program was not liked, as compared to if it was turned on after start and watched until finish.

For at least the above content features and context features, the rating for a feature f in the aggregated profile 104b may be multiplied by a suitable weight factor w(f) to impose different emphasis or importance to different features in the feature vector. The weight w(f) for a feature f may further be a combination of a local weight l(f) and a global weight g(f) as follows:

w(f)=l(f)*g(f) (2)

where the local weight l(f) refers to a particular item and the global weight g(f) refers to any items. The weights above can be predefined in any optional manner.

As mentioned above, the aggregated profile 104b may be represented by a vector Xₜ for each sampling period t, each vector having plural coordinates representing the predefined features. In other words, the feature values in the aggregated profile are defined in the feature vector Xₜ as coordinates corresponding to the predefined features of a sampling period t. The aggregated profile may further be represented as a matrix X with multiple rows for different feature vectors of consumption samples and multiple columns for the N predefined features, where each row in matrix X has a feature vector valid for a corresponding sampling period.

Then, the profile analyser 104 extracts individual taste profiles 104d from the aggregated profile 104b by applying an ICA algorithm 104c to the ratings in the aggregated profile, each taste profile reflecting a distinct taste amongst the set of persons 100. As mentioned above, the ICA algorithm 104c is basically capable of separating a multivariate signal into additive subcomponents, which can be applied on the above matrix X to produce a matrix S with rows containing feature values of the individual taste profiles 104d. In this process, matrix S can be solved in equation (1) in the manner described above. The taste profiles 104d can thus be defined in the form of feature vectors with coordinates corresponding to those in the aggregated profile 104b, although the rating values in the taste profiles 104d are different describing the individual taste profiles.

The profile analyser 104 then provides the generated taste profiles 104d to a recommendation system 106 or equivalent in a suitable manner, thereby enabling the recommendation system 106 to create and adapt customized recommendations of items 110 for the respective individual taste profiles 104d. The taste profiles 104d may be sent to the recommendation system 106 or stored in a suitable profile storage 108 accessible for the recommendation system 106, as indicated by dashed arrows. This solution is not limited to any particular way of providing the taste profiles 104d to recommendation system 106.

The recommendation system 106 may then present the item recommendations 110 to one or more of the persons 100, e.g. presented on the TV set 100 or otherwise, which is however outside the scope of this solution. The process of creating customized item recommendations for the individual taste profiles in a recommendation system 106 or equivalent, is likewise outside the scope of this solution.

As mentioned above, a sampling period can be triggered in different ways, during which a set of feature ratings is determined to form a feature vector, i.e. a row in the matrix X. Some exemplifying trigger mechanisms will now be described with reference to FIGS. 2a-2c. It is generally possible to obtain distinct and hopefully truthful taste profiles if it can be assumed that the same set of persons are likely present at the consumption device during each distinct sampling period, thus sharing the consumption of items. The sampling period should therefore be triggered accordingly, e.g. as follows.

In FIG. 2a, a sampling period t starts when it is detected that the consumption device is powered on or otherwise activated for consumption and the sampling period t ends when it is detected that the consumption device is powered off or otherwise de-activated. The figure also illustrates that consumption of various items and any other factors relevant for the predefined features, e.g. relating to a current context, are registered during period t. In this example, it is assumed that the same set of persons are present during the entire powered-on period, i.e. the sampling period t, or at least during a significant part of it.

FIG. 2 b illustrates another example where a sampling period t starts when it is detected that one or more persons enters or leaves an area close to the consumption device, such as a room or similar, and the sampling period t ends when it is again detected that one or more persons enters or leaves the room or area, with the reasonable assumption that the same set of persons are present during period t. In this embodiment, the sampling periods are thus triggered whenever the set of persons present is changed by one or more people entering or leaving. The trigger mechanisms of the above FIGS. 2a and 2b can also be combined in any optional manner, e.g. as shown in FIG. 2c where the sampling period t starts when the device is powered on and ends when a person enters or leaves the room or area. The other way round is also possible. Thus, both mechanisms, based on device activity and person changes, can be used at the same time.

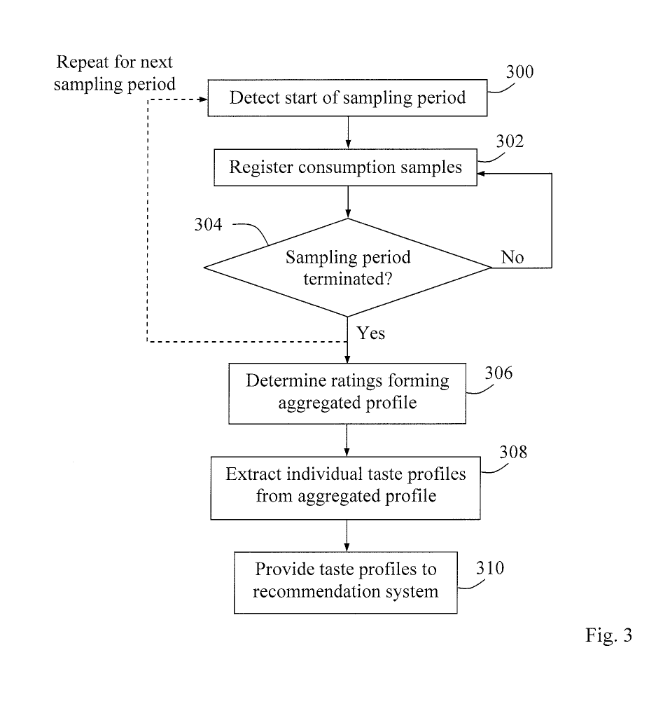

A procedure for enabling creation of customized recommendations of items for one or more persons using a consumption device, will now be described with reference to the flow chart in FIG. 3. This procedure may be executed by a node generally referred to as “profile analyser” in this description, e.g. the profile analyser 104 of FIG. 1. In a first shown action 300, the start of a sampling period is detected, e.g. in the manner described for any of FIGS. 2a-c above. In a next action 302, the profile analyser registers consumption samples referring to the consumption of items by means of the consumption device. It is then determined in a further action 304 whether the sampling period has terminated yet. If not, the registration of consumption samples may continue by returning to action 302.

If it has been detected in action 304 that the sampling period has terminated, e.g. in the manner described for any of FIGS. 2a-c above, the profile analyser determines ratings of a plurality of predefined features from the registered consumption samples, in a further action 306. The determined ratings thus form an aggregated profile reflecting an aggregated taste of the one or more persons having used the consumption device. Then, in a following action 308, the profile analyser extracts individual taste profiles from the aggregated profile by applying an ICA algorithm to the ratings in the aggregated profile. As mentioned above, the ICA algorithm is capable of separating a multivariate signal into additive subcomponents, and each taste profile reflects a distinct taste amongst the one or more persons. Finally, in an action 310, the profile analyser provides one or more of the individual taste profiles to a recommendation system, which is thereby able to create one or more customized recommendations of items adapted for at least one of the provided individual taste profiles.

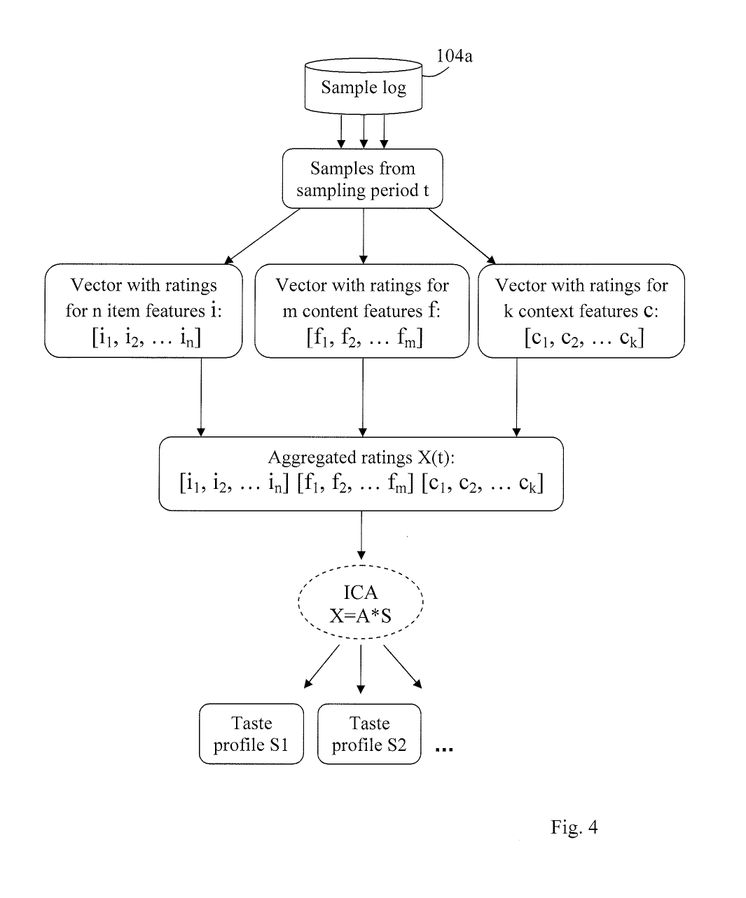

FIG. 4 illustrates an exemplifying scheme of determining individual taste profiles from consummations of items sampled from a consummation device, which may be executed by the profile analyser 104 of FIG. 1. The consumption samples are registered in the sample log 104a. Samples from a particular sampling period t are used for determining ratings of a plurality of predefined features, which in this case are divided into the above-described categories of n item features “i” referring to identities of the items, m content features “f” referring to descriptions of the items, and k context features “c” referring to a context prevalent when the items were consumed. Corresponding vectors can be formed from the determined feature ratings, i.e. [i₁, i₂, . . . iₙ], [f₁, f₂, . . . fₘ] and [c₁, c₂, . . . cₖ], respectively.

These vectors can then be combined into a feature vector for aggregated ratings X(t) for the sampling period t, as

[i₁, i₂, . . . iₙ] [f₁, f₂, . . . fₘ] [c₁, c₂, . . . cₖ], which thus forms or defines the aggregated profile. Then, the ICA algorithm is applied according to equation (1) to obtain the individual taste profiles S1, S2, . . . .

An exemplifying arrangement in a profile analyser will now be described with reference to the block diagram FIG. 5 in which some reference numbers have been reused from FIG. 1 including the set of persons 100, the consumption device 102 and the recommender system 106. According to this arrangement, the profile analyser 500 is configured to enable creation of customized recommendations of items for one or more persons 100 using the consumption device 102. The profile analyser 500 comprises a registering module 500a adapted to register consumption samples referring to the consumption of items by means of the consumption device, which may be collected in a sample log 500b. The profile analyser 500 also comprises a rating module 500c adapted to determine ratings of a plurality of predefined features from the registered consumption samples, the ratings forming an aggregated profile reflecting an aggregated taste of the one or more persons.

The profile analyser 500 further comprises a profile module 500d adapted to extract individual taste profiles 104d from the aggregated profile by applying an ICA algorithm to the ratings in the aggregated profile, the ICA algorithm being capable of separating a multivariate signal into additive subcomponents. Each taste profile reflects a distinct taste amongst the one or more persons. The profile analyser 500 further comprises a providing module 500e adapted to provide one or more of the individual taste profiles to a recommendation system 106 to enable creation of one or more customized recommendations of items adapted for at least one of the individual taste profiles.

It should be noted that FIG. 5 merely illustrates various functional modules or units in the profile analyser 500 in a logical sense, although the skilled person is free to implement these functions in practice using suitable software and hardware means. Thus, the invention is generally not limited to the shown structures of the profile analyser 500, while its functional modules 500a-e may be configured to operate according to the features described for FIGS. 1-4, where appropriate.

The functional modules 500a-e described above can be implemented in the profile analyser 500 as program modules of a computer program comprising code means which when run by a processor “P” in the profile analyser 500 causes the profile analyser 500 to perform the above-described functions and actions. The processor P may be a single CPU (Central processing unit), or could comprise two or more processing units. For example, the processor P may include general purpose microprocessors, instruction set processors and/or related chips sets and/or special purpose microprocessors such as ASICs (Application Specific Integrated Circuit). The processor P may also comprise a memory for caching purposes.

The computer program may be carried by a computer program product in the form of a memory “M” in the profile analyser 500 connected to the processor P. The computer program product or memory M comprises a computer readable medium on which the computer program is stored. For example, the memory M may be a flash memory, a RAM (Random-access memory), a ROM (Read-Only Memory) or an EEPROM (Electrically Erasable Programmable ROM), and the program modules could in alternative embodiments be distributed on different computer program products in the form of memories within the profile analyser 500.

The above profile analyser 500 and functional modules 500a-e can be configured according to various optional embodiments. In a possible embodiment, the registering module is further adapted to register the consumption samples during one or more sampling periods. Each sampling period may start when the consumption device is activated or when a change of present persons is detected, and may end when the consumption device is de-activated or when a change of present persons is detected.

The ratings in the aggregated profile may be values of the predefined features which may comprise at least one of: item features referring to identities of the items, content features referring to descriptions of the items, and context features referring to a context prevalent when the items were consumed.

In another possible embodiment, the rating module is further adapted to define the feature values in the aggregated profile as a feature vector Xₜ comprising coordinates which correspond to the predefined features of a sampling period t. In that case, the profile module may be further adapted to extract the individual taste profiles by determining values of the predefined features in the above-described matrix S defining the taste profiles from a matrix X defining the aggregated profile, and by solving matrix S from the above equation (1) using the ICA algorithm, where A is a transformation matrix. As described above, each row in matrix S contains feature values of an individual taste profile, and each row in matrix X contains feature values of a sampling period.

In another possible embodiment, the rating module is further adapted to multiply the rating for a feature f in the aggregated profile by a weight factor w(f) to impose a corresponding emphasis or importance to the feature f. For example, the weight factor w(f) may be determined from local and global weights using equation (2), as described above.

Some advantages that may be achieved with this novel procedure and arrangement for enabling creation of customized recommendations of items, as compared to conventional solutions, may include:
1) No manual input is required from the users such as login and identification.
2) It is not necessary to identify which persons are using the consumption device, such as face detection, which could be perceived as intrusive of privacy and integrity.
3) The taste profiles are not matched to specific persons which further protects their privacy and integrity.
4) It is possible to define taste profiles with great accuracy and refinement, thus enabling more relevant recommendations and enhancing the user experience.
5) Item providers are able to offer and sell more attractive items.

While the invention has been described with reference to specific exemplary embodiments, the description is generally only intended to illustrate the inventive concept and should not be taken as limiting the scope of the invention. The invention is defined by the appended claims.

1. A method of enabling creation of customized recommendations of items for one or more persons using a consumption device, the method comprising:
registering consumption samples referring to the consumption of items by operation of said consumption device;
determining ratings of a plurality of predefined features from the registered consumption samples, said ratings forming an aggregated profile reflecting an aggregated taste of said one or more persons;
extracting individual taste profiles from the aggregated profile by applying an ICA (Independent Component Analysis) algorithm to said ratings in the aggregated profile, the ICA algorithm separating a multivariate signal into additive subcomponents, each taste profile reflecting a distinct taste amongst said one or more persons; and
providing one or more of said individual taste profiles to a recommendation system for creation of one or more customized recommendations of items adapted for at least one of said individual taste profiles.

2. The method according to claim 1, wherein the consumption samples are registered during one or more sampling periods, each of the one or more sampling periods starting when the consumption device is activated or when a change of present persons is detected, and ending when the consumption device is de-activated or when a change of present persons is detected.

3. The method according to claim 1, wherein the ratings in the aggregated profile are values of the predefined features, said predefined features comprising at least one of: item features referring to identities of said items, content features referring to descriptions of said items, and context features referring to a context prevalent when said items were consumed.

4. The method according to claim 3, wherein said feature values in the aggregated profile are defined as a feature vector Xₜ comprising coordinates corresponding to said predefined features of a sampling period t.

5. The method according to claim 4, wherein extracting the individual taste profiles comprises determining values of said predefined features in a matrix S defining the taste profiles, each row in the matrix S containing feature values of an individual taste profile, from a matrix X defining the aggregated profile, each row in the matrix X containing feature values of a sampling period, by solving matrix S from X=A*S, using said ICA algorithm, where A is a transformation matrix.

6. The method according to claim 1, wherein the rating for a feature f in the aggregated profile is multiplied by a weight factor w(f) to impose a corresponding emphasis or importance to said feature f.

7. The method according to claim 6, wherein said weight factor w(f) is a combination of a local weight l(f) and a global weight g(f) as follows:
w(f)=l(f)*g(f)
where the local weight l(f) refers to a particular item and the global weight g(f) refers to any items.

8. The method according to claim 1, wherein the consumption device is a TV set or STB (Set Top Box) and the items are TV programs.

9. An arrangement in a profile analyser configured to enable creation of customized recommendations of items for one or more persons using a consumption device, the arrangement comprising:
a registering module adapted to register consumption samples referring to the consumption of items by operation of said consumption device;
a rating module adapted to determine ratings of a plurality of predefined features from the registered consumption samples, said ratings forming an aggregated profile reflecting an aggregated taste of said one or more persons;
a profile module adapted to extract individual taste profiles from the aggregated profile by applying an ICA (Independent Component Analysis) algorithm to said ratings in the aggregated profile, the ICA algorithm separating a multivariate signal into additive subcomponents, each taste profile reflecting a distinct taste amongst said one or more persons; and
a providing module adapted to provide one or more of said individual taste profiles to a recommendation system for creation of one or more customized recommendations of items adapted for at least one of said individual taste profiles.

10. The arrangement according to claim 9, wherein the registering module is further adapted to register the consumption samples during one or more sampling periods, each of the one or more sampling periods starting when the consumption device is activated or when a change of present persons is detected, and ending when the consumption device is de-activated or when a change of present persons is detected.

11. The arrangement according to claim 9, wherein the ratings in the aggregated profile are values of the predefined features, said predefined features comprising at least one of: item features referring to identities of said items, content features referring to descriptions of said items, and context features referring to a context prevalent when said items were consumed.

12. The arrangement according to claim 11, wherein the rating module is further adapted to define said feature values in the aggregated profile as a feature vector Xₜ comprising coordinates corresponding to said predefined features of a sampling period t.

13. The arrangement according to claim 12, wherein the profile module is further adapted to extract the individual taste profiles by determining values of said predefined features in a matrix S defining the taste profiles, each row in the matrix S containing feature values of an individual taste profile, from a matrix X defining the aggregated profile, each row in the matrix X containing feature values of a sampling period, and by solving matrix S from X=A*S, using said ICA algorithm, where A is a transformation matrix.

14. The arrangement according to claim 9, wherein the rating module is further adapted to multiply the rating for a feature f in the aggregated profile by a weight factor w(f) to impose a corresponding emphasis or importance to said feature f.

15. The arrangement according to claim 14, wherein said weight factor w(f) is a combination of a local weight l(f) and a global weight g(f) as follows:
w(f)=l(f)*g(f)
where the local weight l(f) refers to a particular item and the global weight g(f) refers to any items.
